(19) United States
(12) Patent Application Publication
(10) Pub. No.: US 2018/0209600 A1
(43) Pub. Date: Jul. 26, 2018

(54) LIGHTING FIXTURE

(71) Applicants: Lin Yang, Shenzhen (CN); Hai Yang, Shenzhen (CN); Jinliang Zhang, Baldwin Park, CA (US)

(72) Inventors: Lin Yang, Shenzhen (CN); Hai Yang, Shenzhen (CN); Jinliang Zhang, Baldwin Park, CA (US)

(21) Appl. No.: 15/880,518

(22) Filed: Jan. 25, 2018

Related U.S. Application Data
(60) Provisional application No. 62/450,463, filed on Jan. 25, 2017.

(51) Int. Cl. F21S 6/00; F21K 9/232; F21V 29/83; F21V 3/06; F21V 23/00

(52) U.S. Cl. CPC F21S 6/002; F21K 9/232; F21W 2131/30; F21V 3/06; F21V 23/001; F21V 29/83

(57) ABSTRACT

In one aspect, a lighting fixture may include a light cover, a base and a power cord. In one embodiment, the light cover is hollow to receive a light bulb and made by crystal salt that can be used to emit negative ions to enhance the user's health. In another embodiment, a connecting plate is secured at a bottom portion of the light cover, and the connecting cover has a plurality of screw holes. The base has a circular operating plate that has a plurality of heat dissipating holes surrounding the operating plate to dissipate the heat generate from the light bulb. The operating plate also has a plurality of screw holes corresponding to the screw holes of the connecting plate, so when the screw holes on the operating plate are aligned with the screw holes on the connecting plate, the screws can be inserted into these screw holes to secure the light cover on the base.

### CROSS-REFERENCE TO RELATED APPLICATIONS

This application claims priority under 35 U.S.C. § 119 (e) to U.S. Provisional Patent Application Ser. No. 62/450,463 filed on Jan. 25, 2017, the entire contents of which are hereby incorporated by reference.

### FIELD OF THE INVENTION

The present invention relates to a lighting fixture, and more particularly to a crystal salt lamp.

### BACKGROUND OF THE INVENTION

Conventionally, lamps are served for only illumination with little or no decorative features, let alone health care and environmental protection features. Recently, crystal salt lamps have become more and more popular. The cover of the salt lamp is made of natural salt crystal ore, which was formed 260 million years ago in certain countries in Europe and Asia. The cover of the crystal salt lamp is hollow and a bulb can be disposed therein, and when the light is turned on, some negative ions can be generated from the salt lamp due to the heat generated by the light bulb.

The crystal salt lamp is a special lighting fixture with some effects to improve the user's health and protect the environment. However, conventional crystal salt lamps are disadvantageous because there is usually no engagement between the crystal salt lamp and the base thereof, so when an external force is accidentally applied to the lamp, it may be separated from the base and broken for the worse scenario. Therefore, there remains a need for a new and improved crystal salt lamp with a base that is easy to attach and detach from the lamp.

### SUMMARY OF THE INVENTION

It is an object of the present invention to provide a crystal salt lighting fixture that is configured to emit negative ions to fight against electromagnetic radiation.

It is another object of the present invention to provide a crystal salt lighting fixture with a modern stainless steel base to enhance safety and product lifespan.

It is a further object of the present invention to provide a crystal salt lighting fixture that can be used to purify air to enhance the user's health.

In one aspect, a lighting fixture may include a light cover, a base and a power cord. In one embodiment, the light cover is hollow to receive a light bulb and made by crystal salt that can be used to emit negative ions to enhance the user's health. In another embodiment, a connecting plate is secured at a bottom portion of the light cover, and the connecting cover has a plurality of screw holes.

The base has a circular operating plate that has a plurality of heat dissipating holes surrounding the operating plate to dissipate the heat generate from the light bulb. The operating plate also has a plurality of screw holes corresponding to the screw holes of the connecting plate, so when the screw holes on the operating plate are aligned with the screw holes on the connecting plate, the screws can be inserted into these screw holes to secure the light cover on the base.

In another aspect, a lighting fixture may include a main body, a power cord, and a receiving space formed within the lighting fixture. In one embodiment, the main body may include a cover plate that is configured to protect a light bulb and can be removed from the receiving space. The light bulb is secured at nearly a center portion of the receiving space. It is noted that the cover plate has a plurality of screw holes to secure the cover plate in the receiving space with a plurality of screws.

In an exemplary embodiment, a plurality of crystal salt units can be disposed in the receiving space. As stated above, when the crystal salt units are heated, some negative ions can be generated to fight against electromagnetic radiation to enhance the user's health. Furthermore, the crystal salt units can be easily added or removed from the receiving space according to the user's preference.

Comparing with conventional crystal salt lighting fixture, the present invention is advantageous because the light cover and the base are engaged with each other via screws, so the light cover will not be easily separated from the base to raise the safety concerns. Furthermore, the light bulb can be well protected by the cover plate and the crystal salt units can be easily added or removed from the receiving space according to the user's preference.

### BRIEF DESCRIPTION OF THE DRAWINGS

FIG. 1 illustrates one aspect of the lighting fixture in the present invention.

FIG. 2 illustrates the light cover and base of the lighting fixture shown in FIG. 1.

FIG. 3 illustrates another aspect of the lighting fixture in the present invention.

FIG. 4 illustrates the main body and cover plate of the lighting fixture shown in FIG. 3.

FIG. 5 illustrates one embodiment of the lighting fixture shown in FIG. 3.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In order to further understand the goal, characteristics and effect of the present invention, a number of embodiments along with the drawings are illustrated as following:

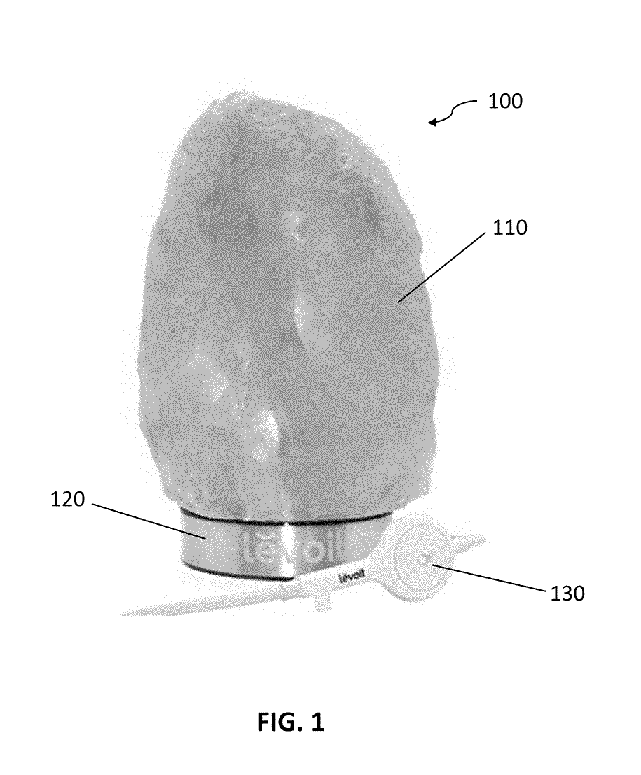

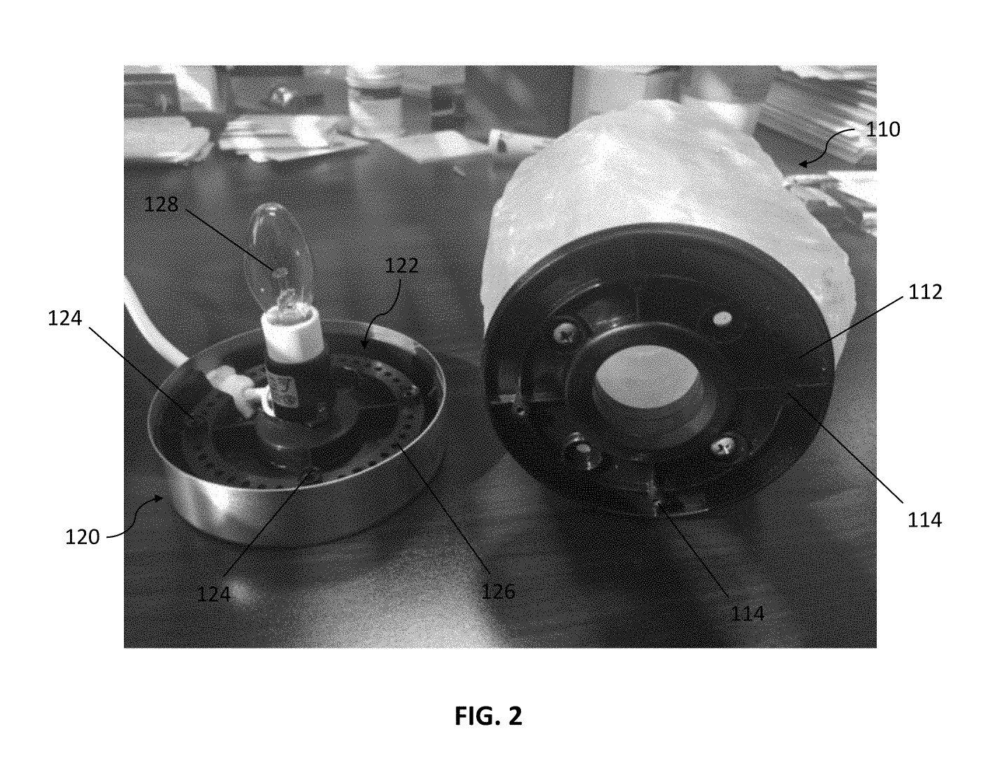

In one aspect, as shown in FIGS. 1 and 2, a lighting fixture 100 may include a light cover 110, a base 120 and a power cord 130. In one embodiment, the light cover 110 is hollow to receive a light bulb 128 and made by crystal salt that can be used to emit negative ions to enhance the user's health. In another embodiment, a connecting plate 112 is secured at a bottom portion of the light cover, and the connecting cover 112 has a plurality of screw holes 114.

The base 120 has a circular operating plate 122 that has a plurality of heat dissipating holes 126 surrounding the operating plate 122 to dissipate the heat generate from the light bulb 128. The operating plate 122 also has a plurality of screw holes 124 corresponding to the screw holes 114 of the connecting plate 112, so when the screw holes 124 on the operating plate 122 are aligned with the screw holes 114 on the connecting plate 112, the screws can be inserted into these screw holes to secure the light cover 110 on the base 120.

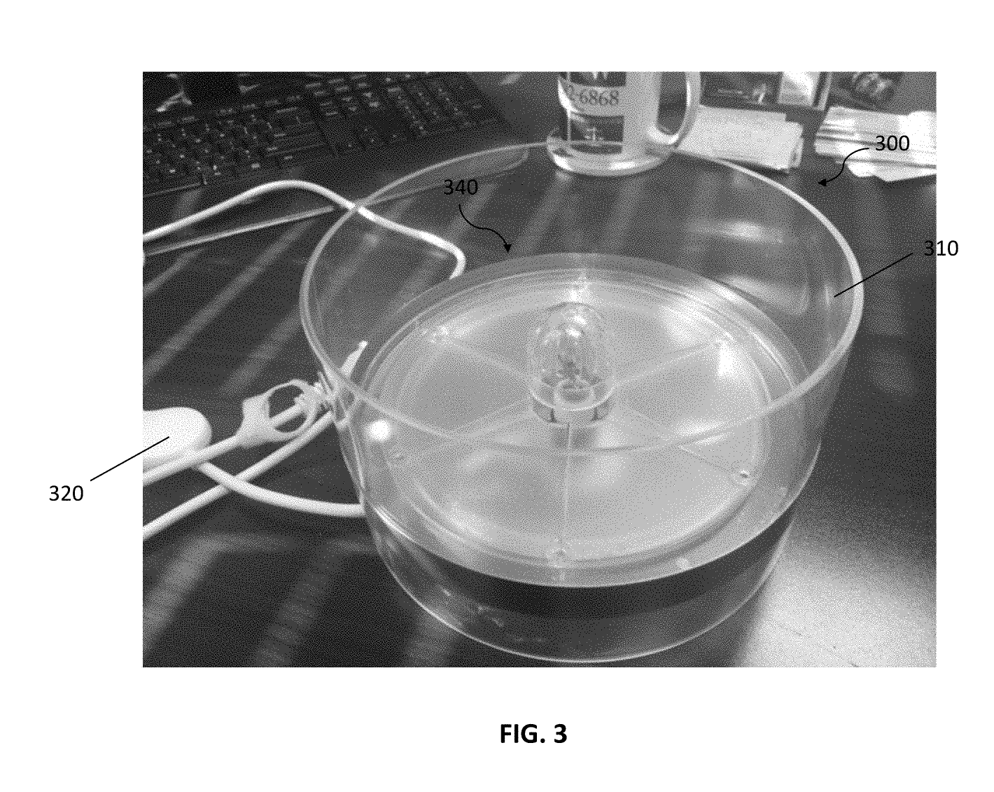

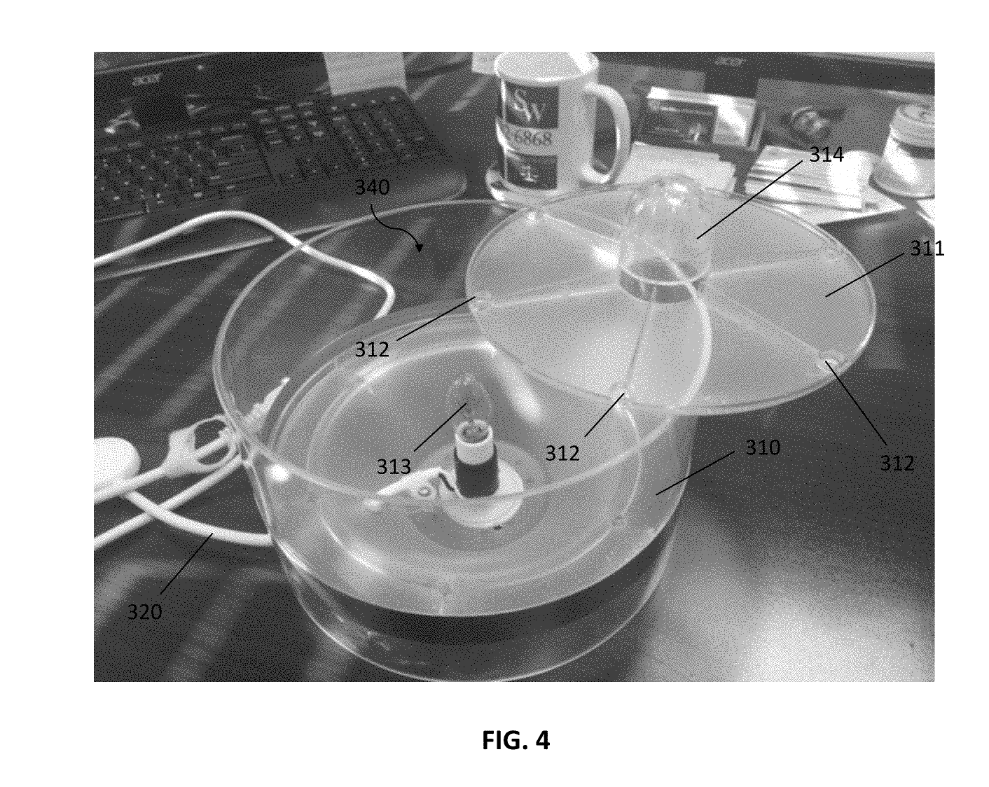

In another aspect, a lighting fixture 300 may include a main body 310, a power cord 320 and a receiving space 340 formed within the lighting fixture 300 as shown in FIGS. 3 and 4. In one embodiment, the main body 310 may include a cover plate 311 that is configured to protect a light bulb 313 and can be removed from the receiving space 340. The light bulb 313 is secured at nearly a center portion of the receiving space 340 and covered by a hollow receiving portion 314 of the as shown in FIG. 4. It is noted that the cover plate 311 has a plurality of screw holes 312 to secure the cover plate 311 in the receiving space 340 with a plurality of screws.

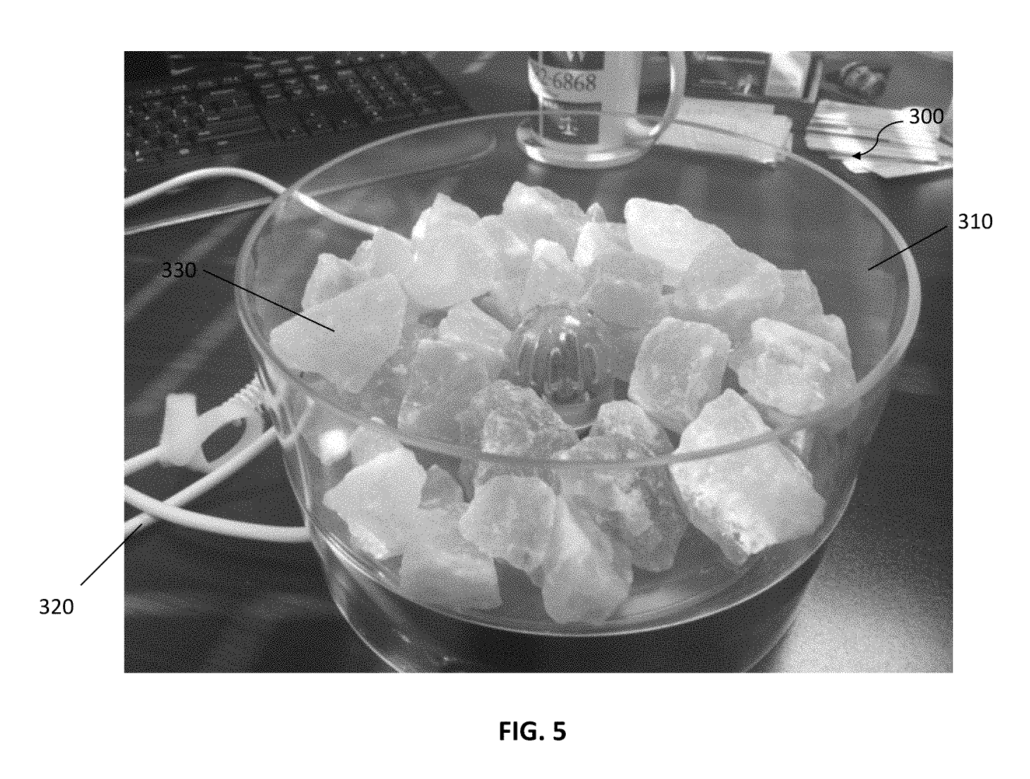

In an exemplary embodiment, a plurality of crystal salt units 330 can be disposed in the receiving space 340 as shown in FIG. 5. As stated above, when the crystal salt units 330 are heated, some negative ions can be generated to fight against electromagnetic radiation to enhance the user's health. Furthermore, the crystal salt units 330 can be easily added or removed from the receiving space 340 according to the user's preference.

Comparing with conventional crystal salt lighting fixture, the present invention is advantageous because the light cover and the base are engaged with each other via screws, so the light cover will not be easily separated from the base to raise the safety concerns. Furthermore, the light bulb can be well protected by the cover plate and the crystal salt units can be easily added or removed from the receiving space according to the user's preference.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A lighting fixture comprising a light cover and a base, wherein the light cover is made by crystal salt to emit negative ions and is hollow to receive a light bulb, and a connecting plate having a plurality of connecting screw holes is secured at a bottom portion of the light cover; the base has a circular operating plate having a plurality of base screw holes corresponding to the connecting screw holes of the connecting plate, so when the base screw holes on the operating plate are aligned with the connecting screw holes on the connecting plate, the screws can be inserted into the connecting and base screw holes to secure the light cover on the base.

2. The lighting fixture of claim 1, wherein the base has a plurality of heat dissipating holes surrounding the operating plate to dissipate the heat generate from the light bulb.

3. The lighting fixture of claim 1, further comprising a power cord to provide electric power to the lighting fixture.

4. The lighting fixture of claim 2, further comprising a power cord to provide electric power to the lighting fixture.

5. A lighting fixture comprising a main body, a receiving space within the main body, and a cover plate disposed in the receiving space to support a plurality of crystal salt units, wherein a light bulb is secured at nearly a center portion of the receiving space and the cover plate has a hollow receiving portion to cover and protect the light bulb.

6. The lighting fixture of claim 5, wherein the cover plate is removable from the receiving space.

7. The lighting fixture of claim 5, wherein the cover plate has a plurality of screw holes to secure the cover plate in the receiving space with screws.

8. The lighting fixture of claim 5, further comprising a power cord to provide electric power to the lighting fixture.
